(19) United States
(12) Patent Application Publication
(10) Pub. No.: US 2005/0216754 A1
(43) Pub. Date: Sep. 29, 2005

(54) Method of encrypting digital items delivery through a communication network

(76) Inventor: Natan Ehud, Ramat Gan (IL)

Correspondence Address: KATTEN MUCHIN ROSENMAN LLP, 575 MADISON AVENUE, NEW YORK, NY, 10022-2585, US

(21) Appl. No.: 10/808,234

(22) Filed: Mar. 24, 2004

(51) Int. Cl. H04L 9/32; G06F 11/30; G06F 12/14; H04L 9/00

(52) U.S. Cl. 713/193; 713/201

(57) ABSTRACT

A secure data organization and retrieval method is used for retrieving digital data item from within a network. After receiving a request for storing a digital item, the data item is split into at least three data fragments using a split algorithm. Splitting algorithm random factors in relation to the digital item are recorded. The data fragments are recorded in at least two Internet servers chosen using a location algorithm. Location algorithm random factors in relation to digital item are also recorded. Upon receiving a request for restoring the digital item, data fragments are retrieved according to location algorithm and re-integrated according to the splitting algorithm.

### BACKGROUND OF THE INVENTION

The present invention relates to secure and trusted delivery of digital information. More specifically, the invention relates to techniques, methods and systems for providing reliable, trusted delivery or archive of digital items through the Internet.

For purposes of this disclosure, the term “digital item” is meant to include electronic documents, executable code (e.g., Java applets), and/or any other information capable of being represented in digital form.

There is a great need for convenient techniques to securely handle and deliver digital items between different parties. Existing methods such as express and personal couriers, registered mail, facsimile and electronic mail fulfill some of these needs but these techniques have different problems and are deficient in important ways.

Perhaps the ultimate in secure document handling is the personal trusted courier. The confidentiality, security and reliability provided by a personal trusted document courier has never really been matched by any other form of document delivery. This approach cannot provide the degree of interactivity between the sender and the recipient possible in a world of near instantaneous communications.

A relatively more efficient delivery technique facsimile, facsimile is an electronic-based technology that provides virtually instantaneous document delivery. Since the recipient's facsimile machine receives the transmitted information at the same time the sender's facsimile machine is sending it, delivery is virtually instantaneous. However, sending a document to an unattended facsimile machine in an insecure location may result in the document falling into the wrong hands. They do not, for example, handle digital items such as audio, video, multimedia, and executables, yet these are part and parcel of communications for commerce and other purposes. Thus, despite its many advantages, facsimile transmissions do not provide the very high degree of confidentiality required by extremely sensitive documents, nor do they provide the degree of flexibility required by modern digital communications.

Electronic mail is gaining popularity in an ever increasing rate for sending documents, messages, and/or other digital items. The “Internet explosion” has connected millions of new users to the Internet. Currently, Internet electronic mail provides great advantages in terms of timeliness (nearly instantaneous delivery) and flexibility (any type of digital information can be sent), but suffers from an inherent lack of security. Internet messages must typically pass through a number of different servers to get from sender to recipient, regardless of whether they are located within a single company on an “Intranet” for example, or on Internet servers belonging to different organizations. Unfortunately, any one of those computers can potentially intercept the message and/or keep a copy of it. Moreover, even though some of these systems have limited “return receipt” capabilities, the message carrying the receipt suffers from the same security and reliability problems as the original message.

Cryptography, a mathematical-based technique for encoding, is used to secure the content of messages and for authenticating them. This method is used to prevent eavesdroppers from reading intercepted messages, but the widespread use of such cryptography techniques along cannot solve electronic mail's inherent lack of security. These electronic mail messages, documents and other items (e.g., executable computer programs or program fragments) that might have been sent with them as “attachments,” remain vulnerable. Known in the art are several “privacy enhanced” methods for electronic mail, but these systems have only provided limited improvements in reliability, efficiency and/or security.

In addition to emailing, electronic document delivery is rapidly replacing more conventional document delivery methods in many commercial applications. For example, businesses are storing documents on computers of various types and sizes for the purpose of rendering those documents accessible to remote customers and partners. Those parties of interest may connect to that computer or server using the Internet or a proprietary TCP/IP computer network. In such systems, users access the document server from their remote client computers, locate the relevant document, and transfer these documents across the network.

In many such applications, the document server computer is connected to a network, such as the Internet, that is accessible to a wide range of users who need not have access to the electronic documents stored on the server. If its owner considers the information contained in the electronic documents confidential, then the documents must be secured and protected against unauthorized access. Conventionally, this security is supplied by document encryption. In the various document encryption methods known to those skilled in the art, the secure electronic documents are transferred across the network to a client computer in encrypted form, where they are decrypted using one or more encryption keys made available to authorized users and clients. “Secure Socket Layer” (SSL) is another conventional security protocol in which the electronic documents reside on the server in unencrypted form but are encrypted when transferred across the network to a client.

In light of the shortcomings of prior art, the present inventions provide the confidentiality and security level of a personal trusted courier in a virtually instantaneous transmitting system. It provides techniques, systems and methods which may be used with any form of electronic communications. It is thus the prime object of the present invention to provide an encryption method and system for digital item delivery and archiving on communication network.

### SUMMARY OF THE INVENTION

A data organization and retrieval method for securing digital data item, integrated within networking system of plural network servers, said method comprising the steps of: receiving request for storing digital item, splitting data item to at least three data fragments according to designated algorithm (“split algorithm”) based on random factors, recording the splitting algorithm random factors in relation to digital item, recording all data fragments in at least two Internet servers wherein said servers are chosen out of available selection of internet servers according designated algorithm(“location algorithm”) based on pre defined rules and random factors, recording the location algorithms random factors in relation to digital item, upon receiving request for restoring digital item, retrieving data fragments according to location algorithm, and integrating data fragments according to splitting algorithm.

### BRIEF DESCRIPTION OF THE DRAWINGS

These and further features and advantages of the invention will become more clearly understood in the light of the ensuing description of a few preferred embodiments thereof, given by way of example only, with reference to the accompanying drawings, wherein—

FIG. 1 is a general diagrammatic representation of the prior art environment;

FIG. 2 is a general diagrammatic representation of the environment in which the present invention is implemented;

FIG. 3 is a flow-chart of transmitting and receiving digital items according to the present invention;

FIG. 4 is a flow-chart of the encrypting process of digital items according to the present invention;

FIG. 5 is a flow-chart of decoding digital items according to the present invention;

### DETAILED DESCRIPTION OF THE PREFERRED EMBODIMENTS

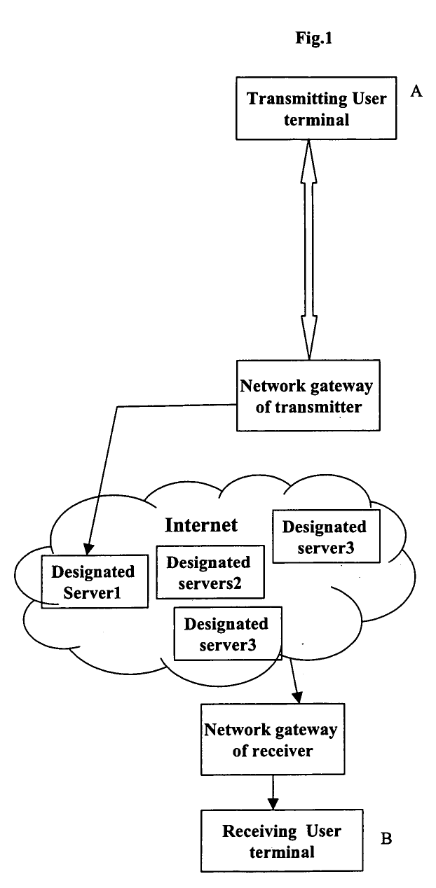

Referring to FIG. 1 of the drawings, it will be seen that a transmitting user A is connected to the receiving user B in accordance with prior art.

Let us assume that the user A desires to send any digital item to user B through the Internet. According to the prior art routine, when digital items are delivered through Internet the conventional way to ensure confidentiality is to encrypt the digital item before transmission and deliver the encrypted item through the network. Such delivery method could not guarantee confidentiality; any items delivered through the net can be intercepted by a third party and decrypted through known methods of cracking the encryption.

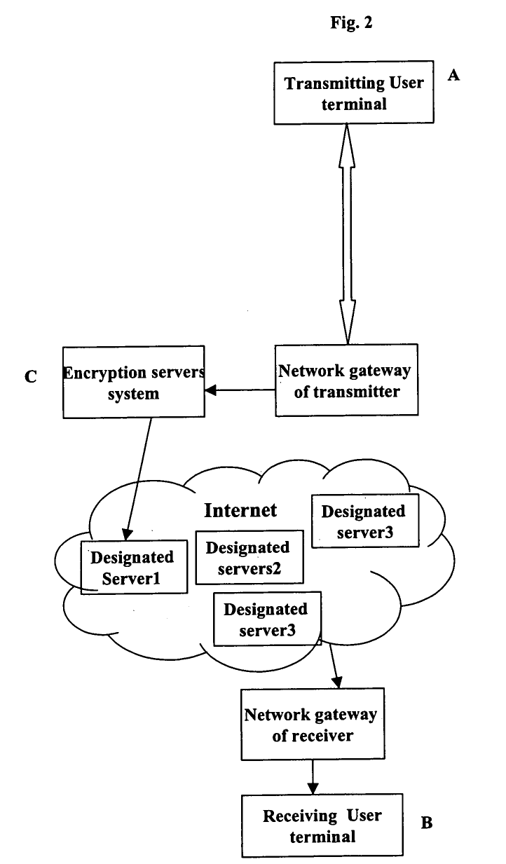

Accordingly, as illustrated in FIG. 2, it is herein proposed that the user A will deliver his data through a third party encryption servers system C. Such system is associated with the gateway server of user A. The encryption sever uses new encryption methodologies, and transfers the desired data to the gateway server of the receiving user B through conventional methods.

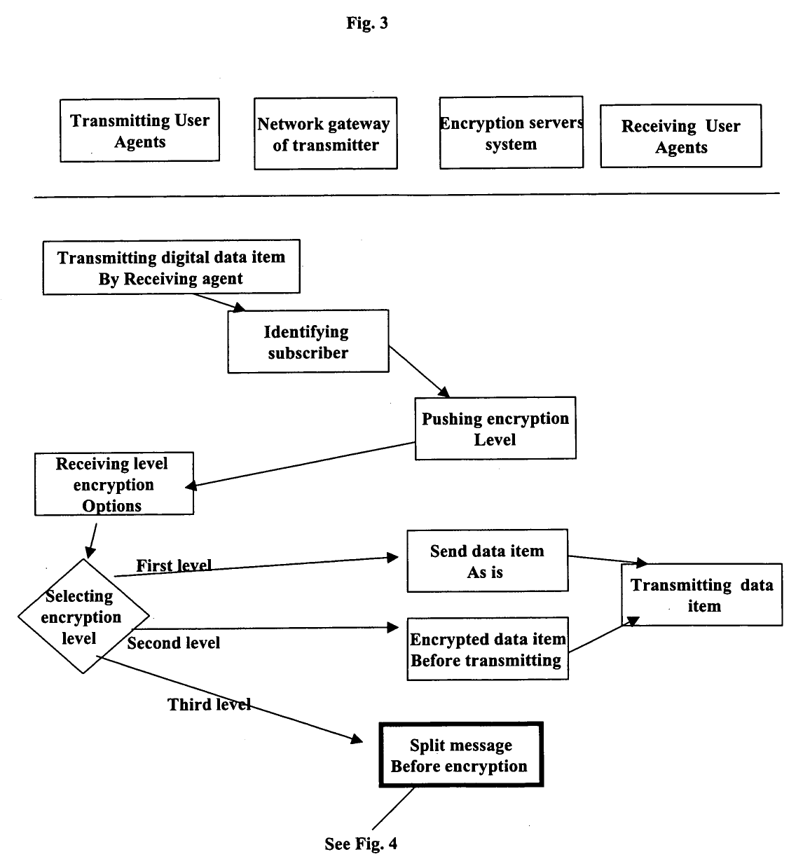

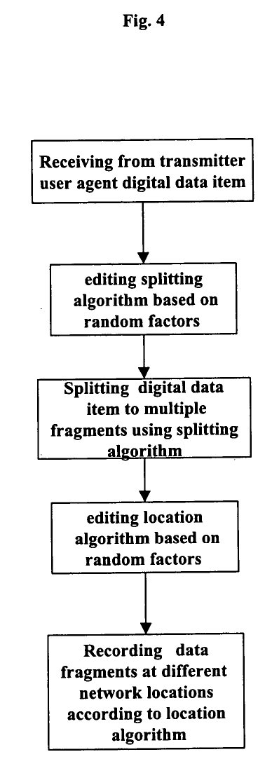

The process of transmitting and receiving digital data items using the encryption server C is illustrated in FIG. 3. As the user enters the request to transmit a given digital item to destination address of user B, the user identity is checked by the encryption system. If the user is identified as a subscribed client of the encryption service, the system sends a preceding message, querying the user for the desired encryption level. If the user selects first level the message is delivered intact immediately to the respective address. In case of selecting the second level of encryption the message is encrypted using any known encryption technologies and transmitted to respective address. If the user selects the thirds level option the delivered data item is processed according to the splitting methodology as illustrated in FIG. 4.

According to splitting process of the present invention the data item is divided to three fragments or more. Splitting is performed according to predefined algorithm, which is based on random parameters determining the number of fragments, fragment size and the method for selecting data input for each fragment. The fragments are not necessarily comprised of sequential data bytes of the data item. For example a fragment can include the first and the last byte of the data item. The created fragments are distributed by the encryption system to designated servers at different network locations. The process of distributing the fragments is based on a predefined algorithm (the distribution algorithm) and random parameters determining the location of the selected designated servers. The encryption system comprises large number of designated servers located at different geographic locations. The distribution algorithm chooses different servers for each delivered item.

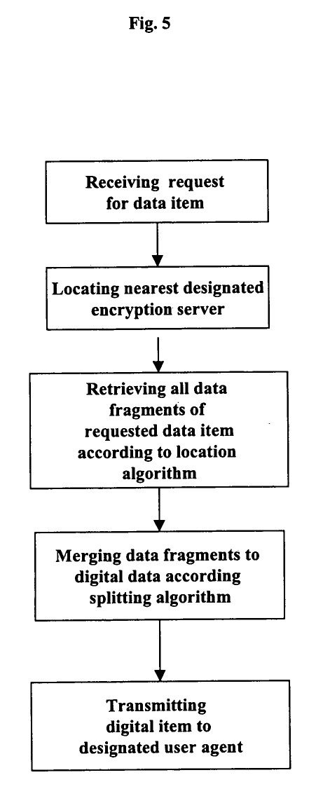

When the receiving user agent requests the delivered digital item, the encryption system reconstructs the data item from the distributed fragments as illustrated in FIG. 5. First, the encryption system selects a designated server for assembling the digital item data. The server is selected according to optimization factors of efficiency and security. Once selected, the server receives the parameters of both distribution and splitting algorithms. Using the respective distribution algorithm the system locates the fragments of the digital items. Once the selected server receives all fragments, it uses the respective splitting algorithm to assemble the delivered digital item.

According to the delivery methodologies, as described above, the transfer of the digital item between the two gateway servers is ensured. Intercepting the delivery of the digital item fragments is of no value to intruders. Further more it is almost impossible to locate all designated servers which store all fragment of the same item. Even if all fragments of the same item are located, there is still the need to crack the splitting algorithm in order to reassemble the fragments.

The method and system of splitting digital items, and recording its fragments at different servers on the network may also be used for archive needs when users want to secure their data archive.

According to an additional embodiment of the present invention it is suggested to provide the user with a client add-ons application for ensuring the delivery of digital items between the user agents and the user gateway (the access point). Such an add-on application will enable the securing of the digital item for client agent such as PC or smart cellular device. The method of splitting and assembling the digital items is implemented in the same methodologies as described above. The encryption server will determine random parameters for the splitting algorithm and transmit them to the user agent. The user agent ad-on application will use these parameters to split the digital item for delivery and transmit the fragments to the respective gateway server.

According to preferred embodiment of the present invention the splitting algorithm is based on pre-formation of the data structure. Converting the digital item from sequential stream of data bytes to a three dimensional (3D) data structure wherein each data byte is identified by three coordinates. The splitting operation based on random parameters splits the 3D data structure to small 3D structures (fragments). When assembling the fragments together at the receiver terminal the data is reorganized according to the original 3D structure.

While the above description contains many specificities, these should not be construed as limitations on the scope of the invention, but rather as exemplification of the preferred embodiments. Those skilled in the art will envision other possible variations that are within its scope. Accordingly, the scope of the invention should be determined not by the embodiments illustrated, but by the appended claims and their legal equivalents.

1. A data organization and retrieval method for securing digital data items, integrated within networking system of plural network servers, said method comprising the steps of:
A. Receiving request for storing digital item;
B. Splitting data item to at least three data fragments according to designated algorithm (“split algorithm”) based on random factors;
C. Recording the splitting algorithm random factors in relation to digital item;
D. Recording all data fragments in at least two Internet servers wherein said servers are chosen out of available selection of internet servers according to designated algorithm (“location algorithm”) based on pre defined rules and random factors;
E. recording the location algorithms random factors in relation to digital item;
F. Upon receiving request for restoring digital item, retrieving data fragments according to location algorithm;
G. Integrating data fragments according to the splitting algorithm.

2. The method of claim 1 wherein the digital item is stored by a first network user and restored by a second network user, further comprising the steps of:
A. First user requesting to store digital data item designated to the second user;
B. Intercepting transmitted data items at first user accessing point in the network;
C. Identifying and associating intercepted data item to first user;
D. Pushing level encryption message to first user;
E. First user selecting encryption level option;
F. In case first level encryption is selected, delivering data item as is to second user directly;
G. In case second level encryption is selected encrypting data item before delivering data transmission to the second user directly;
H. In case third level encryption is selected, splitting data item to at least three data fragments according to designated algorithm (“split algorithm”) based on random factors and recording said algorithm random factors;
I. Recording all data fragments in at least two Internet servers wherein said servers are chosen out of available selection of internet servers according to the designated algorithm (“location algorithm”) based on pre defined rules and random factors;
J. recording the location and splitting algorithm random factors in relation to transmitted message;
K. Upon receiving request for said digital item from second user retrieving data fragments according to the location algorithm;
L. Integrating data fragments according to the splitting algorithm.

3. The method according to claim 2 wherein the splitting algorithm comprises the steps of:
(One) Transforming the item data from sequential data stream to 3D data structure wherein each data byte is identified by three coordinates;
(Two) Split data item according to data organization in the 3D structure.

4. The method according to claim 2 wherein the splitting operation is preformed at the client terminal before it is transmitted to the user network access point, according to predefined splitting algorithm and preset random factors.

5. The method according to claim 2 wherein the splitting operation is preformed at the user network access point according to predefined splitting algorithm and random factors.

6. The method according to claim 1 wherein the random factors of the splitting algorithm determine the fragments characteristics such as number of fragments, the fragments size etc. The method according to claim 1 wherein the fragments contain non sequential data bits of the digital data item. A data organization and retrieval system for securing digital data item, integrated within networking of plural network servers, said system comprising the steps of:
A. Interface communication means for receiving storage requests of digital item;
B. Analyzing module for splitting data item to at least three data fragments according to designated algorithm (“split algorithm”) based on random factors;
C. Recording means for storing the splitting algorithm random factors in relation to digital item;
D. Storage distribution means for recording all data fragments in at least two Internet servers wherein said servers are chosen out of available selection of internet servers according to the designated algorithm (“location algorithm”) based on pre defined rules and random factors wherein the location algorithms random factors are recorded in relation to digital item;
E. Retrieval module for restoring data fragments digital item according to location algorithm; and
F. Integration module for aggregating all data fragments according to splitting algorithm.

7. The system of claim 1 wherein the digital item is stored by a first network user and restored by a second network user, wherein the transmitted data items are Intercepted at first user accessing point in the network enabling the users to select encryption level, wherein according to a first level the data is delivered as is, according to a second level an encryption process is performed on delivered data, according to a third level the data is split into at least three data fragments according to designated algorithm (“split algorithm”) based on random factors, wherein all data fragments are saved on at least two Internet servers wherein said servers are chosen out of available selection of internet servers according to designated algorithm (“location algorithm”) based on predefined rules and random factors;

8. The system according to claim 8 wherein the splitting algorithm is based on 3D data structure organization, wherein each data byte is identified by three coordinates.

9. The system according to claim 8 wherein the splitting operation is preformed at the client terminal before it is transmitted to the user network access point according to predefined splitting algorithm and preset random factors.

10. The system according to claim 8 wherein the splitting operation is preformed at the user network access point according to predefined splitting algorithm and random factors.

11. The system according to claim 8 wherein the random factors of the splitting algorithm determine the fragments characteristics such as number of fragments, the fragments size etc. The system according to claim 8 wherein the fragments contain non sequential data bits of the digital data item.
